(19) United States
(12) Patent Application Publication
(10) Pub. No.: US 2005/0083182 A1
(43) Pub. Date: Apr. 21, 2005

(54) Device with one or more indicators

(76) Inventor: Carl D. Contadini, Terryville, CT (US)

Correspondence Address: Arthur G. Schaier;Carmody & Torrance LLP, 50 Leavenworth Street, P.O. Box 1110, Waterbury, CT, 06721-1110, US

(21) Appl. No.: 10/686,312

(22) Filed: Oct. 15, 2003

(51) Int. Cl. G08B 1/00

(52) U.S. Cl. 340/309.16; 340/635

(57) ABSTRACT

A device that includes at least one consumable source that decreases in effectiveness over time. The device comprises a timer, operatively coupled to the consumable source, for maintaining the duration that the at least one consumable source is in use; and an effectiveness indicator, operatively coupled to the timer, for indicating when the timer has reached a preset duration. In an alternative embodiment, the device may include a sensor for sensing the effectiveness of the at least one consumable source.

### CROSS REFERENCE TO RELATED APPLICATIONS

This application is a Continuation-in-Part of copending Application Serial No. ______, filed on Oct. 14, 2003, Attorney Docket No. 24044-205A, the subject matter of which is incorporated herein by reference in its entirety.

### BACKGROUND OF THE INVENTION

Many devices contain consumable sources, such as lights, adhesive papers, etc. that are used to perform various functions in the device. For example, a hand dryer may contain a germicidal tube for sterilizing air in the dyer. Over time, the germicidal tube may lose its effectiveness and thus require replacement.

Insect traps, such as described in U.S. Pat. No. 5,915,948, may contain an adhesive paper for immobilizing insects as well as UV lights for attracting insects to the trap, both of which require periodic replacement to continue to perform effectively.

Many of these devices of the prior art do not contain any indicator for alerting the user that the device is not functioning up to its optimal level, or in the alternative, do not indicate when the consumable source has lost its minimally desired amount of effectiveness. In many of such instances, the user must remember when the consumable source was last replaced or risk being reminded only after the device fails to function properly.

Therefore, it is believe that there still remains room for improving the state of the art in this regard, and in particular, a need for a device that is capable of both monitoring and indicating the effectiveness of the consumable source, all for a significant (but not necessarily the sole) purpose of indicating when the consumable source should be replaced. The present invention overcomes the aforementioned deficiencies and provides an improved device for monitoring and indicating the effectiveness of such a consumable source.

### SUMMARY AND OBJECTIVES OF THE PRESENT INVENTION

An object of the present invention is to provide an improved device that monitors and indicates an effectiveness of a consumable source, which may be, by example and not limitation, a light source and/or an adhesive surface.

Another object of the present invention is to provide an improved device that more accurately and effectively alerts a user as to when the consumable source needs replacement, or otherwise should be replaced.

Yet another object and advantage of the present invention is to provide an improved device for use in situations or environments where the effectiveness of the consumable source is not readily discernible or monitorable by a user.

Still other objects and advantages of the invention will in part be obvious and will in part be apparent from the specification.

The invention accordingly comprises the features of construction, combination of elements, arrangement of parts which will be exemplified in the construction, illustration and description hereinafter set forth, and the scope of the invention will be indicated in the claims.

Therefore, and generally speaking, the present invention is directed to a device that includes at least one consumable source that decreases in effectiveness over time. In a preferred embodiment, the device comprises a timer, operatively coupled to the consumable source, for maintaining the duration that the at least one consumable source is in use; and an effectiveness indicator, operatively coupled to the timer, for indicating when the timer has reached a preset duration. In a specific embodiment, the device preferably comprises a controller, operatively coupled intermediate the timer and the indicator, for receiving one or more signals from the timer and transmitting one or more other signals to the indicator, the one or more other signals being based on the one or more signals from the timer to the controller. The device may also comprise an operational indicator, operatively coupled to the controller, for indicating when the device is in a selected operating mode and wherein the effectiveness indicator and the operational indicator are independently controlled by the controller; whereby the operational indicator is capable of indicating that device is operating in the selected mode while the effectiveness indicator is simultaneously indicating an effectiveness of the consumable source. The effectiveness indicator may be visual and/or audible, and a service indicator, for indicating a need for servicing by an individual, may also be provided. Exemplars of consumable sources are light source, such as UV light sources; or adhesive surfaces, whose tackiness effectiveness decreases over time.

In an alternative embodiment, the device preferably comprises a sensor, operatively coupled to the consumable source, for sensing the effectiveness of the at least one consumable source; and an indicator, operatively coupled to the sensor, for indicating an effectiveness of the at least one consumable source. Similar to the first embodiment, this alternative embodiment may also comprise a controller, operatively coupled intermediate the sensor and the indicator, for receiving one or more signals from the sensor and transmitting one or more other signals to the indicator, the one or more other signals being based on the one or more signals from the sensor to the controller. Here too, the device may include an operational indicator for indicating when the device is in a selected operating mode and wherein the effectiveness indicator and the operational indicator are independently controlled by the controller. Likewise, the effectiveness indicator may be visual and/or audible, and a service indicator may also be provided.

### BRIEF DESCRIPTION OF THE DRAWINGS

For a fuller understanding of the invention, reference is had to the following description taken in connection with the accompanying figures, in which:

FIG. 1 is a block diagram of a device constructed in accordance with a first embodiment of the present invention;

FIG. 2 is a block diagram of a device constructed in accordance with an alternative embodiment of the present invention; and

FIG. 3 illustrates an exemplary device constructed in accordance with the present invention, and in particular, as embodied in an insect trap.

Also, while not all elements are labeled in each figure, all elements with the same reference number indicate like or similar parts.

### DETAILED DESCRIPTION OF THE PREFERRED EMBODIMENTS

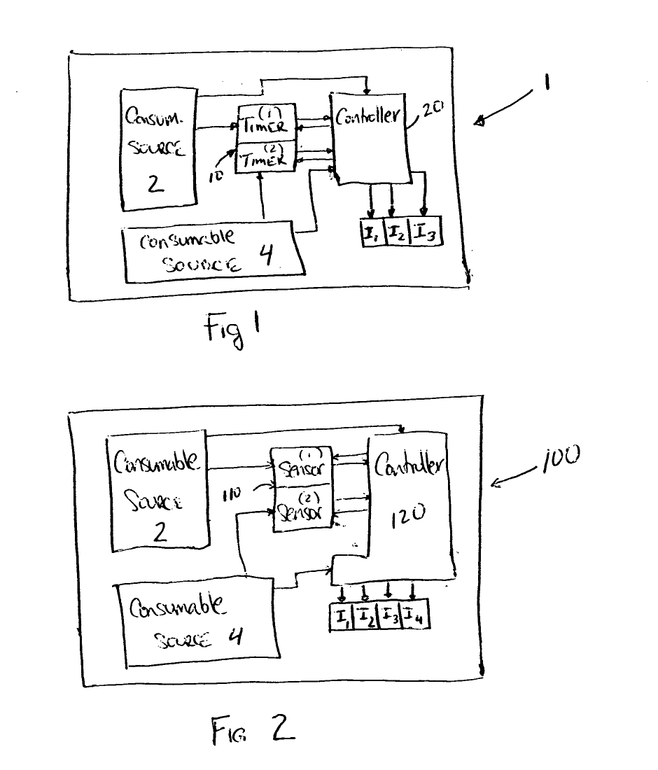

Reference is made to FIGS. 1-3 for a general understanding of a device, generally indicated at 1, 10, 1000 constructed in accordance with the present invention. Specifically, device 1 is intended to comprise at least one consumable source, such as a UV tube 2 and/or an adhesive (i.e. tacky) surface 4. As would be understood in the art, such consumable sources decrease in effectiveness over time (e.g. use).

In the embodiment specifically illustrated in FIG. 1, device 1 comprises a timer, generally indicated at 10, which may be operatively coupled to the consumable source, for maintaining the duration that the at least one consumable source is in use. As illustrated in FIGS. 1 and 3, device 1 and 1000 may comprise a plurality of consumable sources, and therefore, multiple timers may be provided. As would be understood, clearly, one timing device with multiple timer functionality can be used. The construction of FIG. 1 also includes an effectiveness indicator, such as I₁, which is operatively coupled to timer 10, for indicating when timer 10 has reached a preset duration, as discussed below.

As illustrated in FIG. 1, a preferred construction of device 1 may comprise a controller 20, operatively coupled intermediate timer 10 and indicator I₁ for receiving one or more signals from the timer and transmitting one or more other signals to the indicator. One of ordinary skill in the art will readily understand how to provide for such signaling, and will also readily understand how the signals from the controller to the indicator will thus be based on the signals (e.g. the information being transmitted) from timer 10 to controller 20. Thus, FIG. 1 illustrates several control lines, although not all of them need be required, and are a function of the construction and features (and complexity) of the device. These design features are also within the purview of one skilled in the art.

As also illustrated in FIG. 1, device 1 may also comprise an operational indicator I₂, also (and preferably) operatively coupled to controller 20. Here, operational indicator I₂ preferably indicates when device 1 is in a selected operating mode (such as a hand drying mode or insect attracting mode). Preferably, effectiveness indicator I₁ and operational indicator I₂ are independently controlled by controller 20 so that operational indicator I₂ is capable of indicating that device 1 is operating in the selected mode while effectiveness indicator I₁ is simultaneously indicating an effectiveness of the consumable source. In other words, it is possible, by way of the present invention, to provide a device that can simultaneously indicate that the device is operating, and also provide a means for indicating the “effectiveness” of the operation (e.g. that the hand dryer is working/operating, but that the UV tube should be replaced).

Preferably, effectiveness indicator I₁ is preferably visual (such as LED, by way of example and not limitation), and may also be audible, such as via a buzzer, automated voice, or an alarm (periodic beeps), or a combination of all of the foregoing. Mover, any visual indication can be a light that goes “off” to “on” or “on” to off,” depending on the design selected. Therefore, ultimate replacement of the consumable source may take place when the indicator, if visible for example, goes off or when it goes on. Such is mere design choice and not material to the invention.

Device 1 may also comprise a service indicator 13 for indicating that the device needs servicing (e.g. by a trained technician). Again, the service indicator may be visual and/or audible. As constructed in FIG. 1, the need for servicing (and the indication therefore) may be based on the signals from timer 10 to controller 20, as the controller would preferably be the element that processes the information coming from timer 10.

As alluded to above, and more particularly disclosed below, the consumable source may be a light source, an adhesive surface or some other time-related source, whose effectiveness may deteriorate or decline over time (e.g. use).

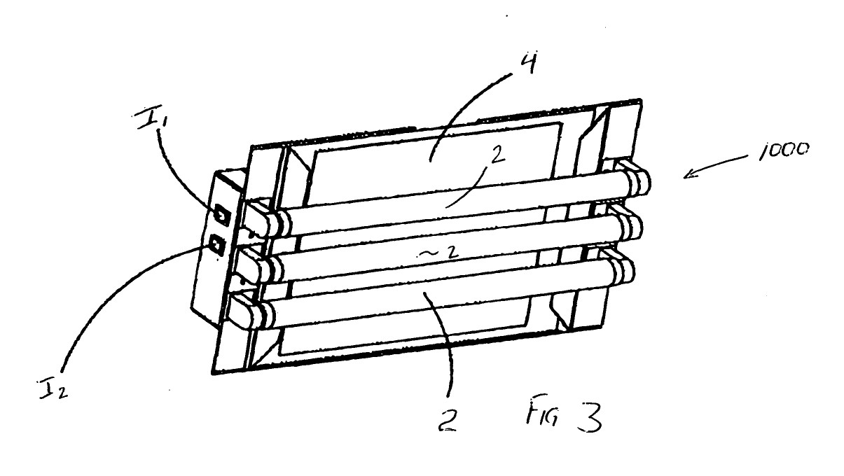

Reference is now briefly made to FIG. 2, wherein an alternative embodiment for a device, generally indicated at 100, is depicted. Here too, device 100 includes at least one consumable source, indicated by reference numbers 2 and/or 4, that decreases in effectiveness over time (e.g. use). In this alternative embodiment, device 100 comprises a sensor generally indicated at 110, which is operatively coupled to the consumable source. Again, there may be more than one sensor, thus preferably providing at least one sensor for each consumable source. Hence, sensor 110 in FIG. 2 is distributed over two sensor blocks for exemplary purposes. Sensor 110 senses the effectiveness of the at least one consumable source, and may do so with sensors that can measure such effectiveness, such as light sensor or electronic nose (which are commercially available) if the consumable source was an insecticide, fragrance or the like. Again, such sensors would be well known to one skilled in the art. Hereto, in the most general embodiment, an indicator, such as indicator II is operatively coupled to the consumable source and indicates an effectiveness of the at least one consumable source. It should be understood that in both embodiments the effectiveness is preferably a quantifiable and/or qualitative amount based on one or more criterions, as would be well understood in the art, and may be preset by the designer or manufacturer, based on recommended desired effectiveness.

Similarly, device 100 preferably comprises a controller 120, which operates and has similar features and construction as that of controller 20, and therefore the details thereof are omitted for brevity. In a similar manner, device 100 may comprise a similarly designed operational indicator I₂ and service indicator I₃ as those provided in device 1. Therefore, except for the differing features of timer 10 and sensor 110, the construction, features and advantages set forth above and illustrated in FIGS. 1 and 2 are identical. For example, hereto there may be a plurality of consumable sources in any one device and may comprise, but are not limited to, light sources and/or adhesive surfaces (i.e. for insect traps).

To this end, reference is now made particularly to FIG. 3 which illustrates a particular embodiment of the present invention, such as the device illustrated in FIG. 1. However this is by way of example as one skilled in the art would readily appreciate the interchangeability (or combination) of features between and among the embodiments illustrated in FIGS. 1-3.

The device, generally indicated at 1000, illustrated in FIG. 3, is a light trap for attracting flying insects, and preferably comprises two consumable sources, namely one or more UV tubes 2 to attract insects to device 1000 and a sticky (adhesive) surface 4 for trapping/retaining the insects. Also included but not illustrated in this FIG. 3 are two resettable timers, as disclosed above, for maintaining a running time of how long the consumable sources are (or have been) in use.

During operation of device 1000, UV light is emitted from light source 2 at a wavelength deemed attractive to flying insects. Over the course of time, the level of UV light emitted from source 2 will deteriorate to a point roughly, but not exactly, after 8000 hours of continual use such that so little UV light is emitted that the desired or recommended usefulness of the device is negligible. The present invention provides for the indication that the useful life of the source of UV light has expired, and is indicated by an indicator, such as light I₁ (again, a buzzer, alarm and/or voice activation means may be used to provide the indication). Replacement sources of UV light should then be installed. All the embodiments disclosed herein may include a reset button, operatively coupled to timer 10 or one of the controllers, to reset the timer (or the sensor, as the case may be) once the respective consumable source has been replaced. The resetting can be done either manually or automatically, depending on the particular application, as would be understood by those skilled in the art.

Similarly, replacement adhesive substrates 4 should be replaced after a preset or predetermined period of time (again, as set by the user or manufacturer) to combat the fact that the adhesive will dry out over time and/or that the adhesive surface will fill with caught insects. As set forth above, a separate timer and indicator may be provided for each of the consumable sources so that timely replacement can be made.

The present invention is applicable in any device that contains a consumable source whose effectiveness over time is not easily discernible or monitorable. For example, the device may be a hand dryer containing a UV light, such as described in British Patent Application No. 0304825.3, the subject matter of which is incorporated herein by reference in its entirety. Likewise, the device incorporating the present invention may be an insect trap containing a UV light source and an adhesive paper for trapping insects, such as described in U.S. Pat. No. 5,915,948, the subject matter of which is also incorporated herein by reference in its entirety. While these two systems are specifically noted, the invention is not limited to these two embodiments. Other systems containing consumable sources that need periodic replacement would also be discernible to those skilled in the art.

It should also be understood that yet other indicators may be provided. For example, an indicator that indicates that the consumable source is in fact sterilizing the air may be provided. That is, an indicator, such as a light, may be provided to indicate that the UV light source (or the adhesive surface) is above the minimum level of effectiveness. Again, such an indicator may be practically combined with the effectiveness indicator, as would be understood by those skilled in the art. That is, there may be a time period where the device is still sterilizing the air, but the effectiveness falls below a desired value. Hence, it would be advantageous to have a plurality of indicators indicating the exact status and/or effectiveness of the consumable source.

While the invention has been particularly shown and described with respect to preferred embodiments thereof, it will be understood by those skilled in the art that changes in form and details may be made therein without departing from the scope and spirit of the invention. For example, in the case of the hand drying device in which UV germicidal tube is used, the duration of recommended/desired effective may be different from that in the insect trap embedment. For example, a UV tube for the hand dryer embodiment disclosed herein may be after 8760 hours (or one year in any event).

1. A device that includes at least one consumable source that decreases in effectiveness over time, the device comprising:
a timer, operatively coupled to the consumable source, for maintaining the duration that the at least one consumable source is in use; and
an effectiveness indicator, operatively coupled to the timer, for indicating when the timer has reached a preset duration.

2. The device as claimed in claim 1, including a controller, operatively coupled intermediate the timer and the indicator, for receiving one or more signals from the timer and transmitting one or more other signals to the indicator, the one or more other signals being based on the one or more signals from the timer to the controller.

3. The device as claimed in claim 2, including an operational indicator, operatively coupled to the controller, for indicating when the device is in a selected operating mode and wherein the effectiveness indicator and the operational indicator are independently controlled by the controller;
whereby the operational indicator is capable of indicating that device is operating in the selected mode while the effectiveness indicator is simultaneously indicating an effectiveness of the consumable source.

4. The device as claimed in claim 2, wherein the effectiveness indicator is at least one of a visual or audible indicator, and wherein the visual indication may be one of visual indicator going from “off” to “on” or “on” to off”.

5. The device as claimed in claim 4, including a service indicator for indicating a need for servicing by an individual, wherein the service indicator is at least one of visual or audible, and the need for servicing is based on the one or more signals from the timer to the controller.

6. The device as claimed in claim 1, wherein the at least one consumable source is a light source.

7. The device as claimed in claim 1, wherein the at least one consumable source is an adhesive surface.

8. The device as claimed in claim 1, wherein the indicator is at least one of a visual or audible indicator.

9. A device that includes at least one consumable source that decreases in effectiveness over time, the device comprising:
a sensor, operatively coupled to the consumable source, for sensing the effectiveness of the at least one consumable source; and
an indicator, operatively coupled to the sensor, for indicating an effectiveness of the at least one consumable source.

10. The device as claimed in claim 9, including a controller, operatively coupled intermediate the sensor and the indicator, for receiving one or more signals from the sensor and transmitting one or more other signals to the indicator, the one or more other signals being based on the one or more signals from the sensor to the controller.

11. The device as claimed in claim 10, including an operational indicator, operatively coupled to the controller, for indicating when the device is in a selected operating mode and wherein the effectiveness indicator and the operational indicator are independently controlled by the controller;
whereby the operational indicator is capable of indicating that device is operating in the selected mode while the effectiveness indicator is simultaneously indicating an effectiveness of the at least one consumable source.

12. The device as claimed in claim 10, wherein the effectiveness indicator is at least one of a visual or audible indicator, and wherein the visual indication may be one of visual indicator going from “off” to “on” or “on” to off”.

13. The device as claimed in claim 12, including a service indicator for indicating a need for servicing by an individual, wherein the service indicator is at least one of visual or audible, and the need for servicing is based on the one or more signals from the timer to the controller.

14. The device as claimed in claim 9, wherein the at least one consumable source is a light source.

15. The device as claimed in claim 9, wherein the at least one consumable source is an adhesive surface.

16. The device as claimed in claim 9, wherein the indicator is at least one of a visual or audible indicator.

17. The device as claimed in claim 9, wherein the sensor is a timer.
